(19) United States
(12) Patent Application Publication
(10) Pub. No.: US 2025/0348614 A1
(43) Pub. Date: Nov. 13, 2025

(54) NUMERICAL RANGE QUERY METHODS AND APPARATUSES FOR PRIVACY PROTECTION AND INDEX CONSTRUCTION METHODS AND APPARATUSES FOR PRIVACY PROTECTION

(71) Applicant: Alipay (Hangzhou) Information Technology Co., Ltd., Hangzhou (CN)

(72) Inventors: Yu JIN, Hangzhou (CN); Wuqiong PAN, Hangzhou (CN)

(21) Appl. No.: 19/197,848

(22) Filed: May 2, 2025

(30) Foreign Application Priority Data
May 7, 2024 (CN) 202410560204.4

(51) Int. Cl. G06F 21/62; G06F 16/22; G06F 16/245

(52) U.S. Cl. CPC G06F 21/6227; G06F 16/2246; G06F 16/245

(57) ABSTRACT

Implementations of this specification provide a numerical range query method and apparatus for privacy protection and an index construction method and apparatus for privacy protection, and relate to the field of computer technologies. During index construction, a correspondence between m range indexes and n address indexes is established by using a mapping relationship between n data and m numerical range intervals, and an address index and a range index corresponding to the address index are used as a data block, which is stored in a tree-structured database in an oblivious random access manner. When range query is performed on data, a first range index corresponding to a numerical range to be queried is determined by using the foregoing correspondence, a corresponding first leaf node is computed based on the first range index, several corresponding data blocks are read from the tree-structured database in an oblivious random access manner, a target address index is determined from the data blocks, an n-dimensional query vector is generated based on the target address index and n address indexes, and a query result is determined from n pieces of data by using the n-dimensional query vector.

### TECHNICAL FIELD

One or more implementations of this specification relate to the field of computer technologies, and in particular, to a multi-party joint range query method, apparatus, and system for privacy protection.

### BACKGROUND

Range query is a query method in which data or documents that meet a specified range are obtained through filtering based on a specified condition in a database or a search engine. Query may be performed by specifying a start value and an end value of a range, and all results in this range are returned. Data to be queried may be generally stored in a server such as a cloud server. Due to a requirement for privacy protection, data are stored in a device such as a cloud server in an encrypted manner. A user performs range query on data by accessing a device such as a cloud server. When range query is performed on data, a requirement for privacy protection and confidentiality exists.

### SUMMARY

The specification is directed to technical solutions of range query on privacy data, which improves data security and confidentiality.

One or more implementations of this specification describe numerical range query methods and apparatuses for privacy protection and index construction methods and apparatuses for privacy protection, so that confidentiality can be improved as much as possible when range query is performed on privacy data. Example technical solutions are as follows:

According to a first aspect, example implementations provide a numerical range query method for privacy protection, used to perform range query on n pieces of data, where the n pieces of data correspond to n address indexes; and the method includes: determining a first range index corresponding to a numerical range to be queried based on a preset correspondence between m numerical range intervals and range indexes; computing a corresponding first leaf node based on the first range index; reading, in an oblivious random access manner, data blocks corresponding to the first leaf node from a tree-structured database, a data block of the data blocks including an address index and a range index corresponding to the address index; determining a target address index from the data blocks based on the first range index; generating an n-dimensional query vector based on the target address index and the n address indexes; and determining a query result from the n pieces of data based on the n-dimensional query vector.

In an implementation, the computing the corresponding first leaf node based on the first range index includes: computing the corresponding first leaf node based on the first range index and a current query order.

In an implementation, the determining the target address index from the data blocks based on the first range index includes: searching the data blocks for a target data block including the first range index, and using an address index in the target data block as the target address index.

In an implementation, the generating the n-dimensional query vector based on the target address index and the n address indexes includes: constructing an n-dimensional vector corresponding to locations of the n address indexes, setting an element at a location of the target address index in the n-dimensional vector to a preset value that is not 0, and setting another location to 0, to obtain the query vector.

In an implementation, the determining the query result from the n pieces of data based on the n-dimensional query vector includes: obtaining an n-dimensional query result based on a product of the n-dimensional query vector and a same-location element of a data vector, the data vector including the n pieces of data.

In an implementation, the tree-structured database is split into a plurality of tree-structured database shards that are respectively stored in a plurality of storage devices; and the reading the data blocks corresponding to the first leaf node from the tree-structured database includes: separately sending the first leaf node to storage devices of the plurality of storage devices, for the several storage devices to read, in an oblivious random access manner, several data block shards corresponding to the first leaf node from respective tree-structured database shards; receiving the data block shards respectively sent by the several storage devices; and constructing the data blocks based on the data block shards.

In an implementation, after the receiving the data block shards respectively sent by the several storage devices, the method further includes: updating a current query order to obtain an updated query order; computing a corresponding second leaf node based on the first range index and the updated query order; and separately sending the second leaf node to the plurality of storage devices, so that the plurality of storage devices separately update corresponding data blocks in respective tree-structured database shards based on the second leaf node.

In an implementation, a piece of data in the n pieces of data is split into a plurality of data shards to obtain a plurality of shard groups each including n data shards, and the plurality of shard groups are respectively stored in a plurality of storage devices; and where the determining the query result from the n pieces of data based on the n-dimensional query vector includes: splitting the n-dimensional query vector into a plurality of n-dimensional query vector shards; correspondingly sending the plurality of n-dimensional query vector shards to the plurality of storage devices separately, for the plurality of storage devices to determine a query result shard based on respective n-dimensional query vector shards and n data shards; receiving the query result shards sent by the plurality of storage devices; and determining the query result based on the query result shards received from the plurality of storage devices.

According to a second aspect, example implementations provide a numerical range query method for privacy protection, used to perform range query on n pieces of data, where the n pieces of data correspond to n address indexes, a tree-structured database is used to store a data block, a data block of the data blocks includes an address index and a range index corresponding to the address index, the tree-structured database is split into a plurality of tree-structured database shards respectively stored in a plurality of storage devices, and the method is performed by any storage device and includes: receiving a first leaf node sent by a query device, the first leaf node being computed based on a first range index, and the first range index being determined based on a preset correspondence between m numerical range intervals and range indexes and a numerical range to be queried; reading, in an oblivious random access manner, several data block shards corresponding to the first leaf node from tree-structured database shards stored in the storage device; and sending the several data block shards to the query device, for the query device to construct data blocks based on data block shards sent by storage devices, and to determine a query result from the n pieces of data based on an n-dimensional query vector, the n-dimensional query vector being generated based on a target address index and the n address indexes, and the target address index being determined from the data blocks based on the first range index.

In an implementation, the method further includes: receiving a second leaf node sent by the query device, the second leaf node being computed based on the first range index and an updated query order; sorting, based on the second leaf node, the several data block shards by interacting with another storage device, to obtain sorted data block shards, so that each storage device performs same sorting on several data block shards of the storage device; and backfilling the tree-structured database shard with the sorted data block shards.

In an implementation, the storage device includes a storage area and a sorting area, the storage area is used to store the several data block shards corresponding to the first leaf node that are read from the tree-structured database shards, and the sorting area is used to store the sorted data block shards.

According to a third aspect, example implementations provide a numerical range query method for privacy protection, used to perform range query on n pieces of data, where the n pieces of data correspond to n address indexes, a piece of data in the n pieces of data is split into a plurality of data shards to obtain a plurality of shard groups each including n data shards, the plurality of shard groups are respectively stored in a plurality of storage devices, and the method is performed by any storage device and includes: receiving an n-dimensional query vector shard sent by a query device, the n-dimensional query vector shard being obtained through splitting from an n-dimensional query vector, the n-dimensional query vector being generated based on a target address index and the n address indexes, the target address index being determined from data blocks based on a first range index, the first range index being determined based on a preset correspondence between m numerical range intervals and a range index and a numerical range to be queried, and a data block of the data blocks including an address index and a range index corresponding to the address index; determining a query result shard based on the n-dimensional query vector shard and n data shards stored by the storage device; and sending the query result shard to the query device, for the query device to construct a complete query result based on query result shards sent by storage devices.

According to a fourth aspect, example implementations provide a data index construction method for privacy protection, including: determining n address indexes corresponding to n pieces of data, to obtain a first correspondence; constructing m numerical range intervals covering a numerical range of the n pieces of data; determining m range indexes corresponding to the m numerical range intervals, to obtain a second correspondence; separately mapping the n pieces of data to the m numerical range intervals to obtain a first mapping relationship; determining the first correspondence, and the second correspondence, address indexes respectively corresponding to the m range indexes based on the first mapping relationship; and using an address index and a range index corresponding to the address index as a data block, computing a leaf node corresponding to the data block based on the range index, and storing the data block into a tree-structured database based on the leaf node.

In an implementation, the constructing the m numerical range intervals covering the numerical range of the n pieces of data includes: determining a maximum value and a minimum value of the n pieces of data; determining, based on the maximum value and the minimum value, an interval length for constructing a numerical range interval; and constructing the m numerical range intervals based on the interval length.

In an implementation, the determining the interval length for constructing a numerical range interval includes: computing a difference between the maximum value and the minimum value, computing an average value of the difference by using n, and determining the interval length based on the average value.

In an implementation, the constructing the m numerical range intervals based on the interval length includes: successively determining, starting from the minimum value, the m numerical range intervals by using the interval length as a step, m being a value obtained after 1 is added to n.

In an implementation, the determining the address indexes respectively corresponding to the m range indexes includes: corresponding the n address indexes to the m range indexes to obtain an initial correspondence; and filling in invalid address indexes in response to that a quantity of address indexes corresponding to a range index in the initial correspondence is less than a preset quantity of k, so that the quantity of address indexes corresponding to the range index reaches k, k being not less than a maximum value of quantities of address indexes corresponding to a range index in the initial correspondence.

In an implementation, the computing the leaf node corresponding to the data block based on the range index includes: computing the leaf node corresponding to the data block based on the range index and a query order.

In an implementation, the method further includes: splitting the tree-structured database into a plurality of tree-structured database shards, and respectively storing the tree-structured database shards into a plurality of storage devices.

According to a fifth aspect, example implementations provide a numerical range query apparatus for privacy protection, used to perform range query on n pieces of data, where the n pieces of data correspond to n address indexes; and the apparatus includes: a range index corresponding module, configured to determine a first range index corresponding to a numerical range to be queried based on a preset correspondence between m numerical range intervals and range indexes; a leaf node computing module, configured to compute a corresponding first leaf node based on the first range index; a data block reading module, configured to read, in an oblivious random access manner, data blocks corresponding to the first leaf node from a tree-structured database, a data block of the data blocks including an address index and a range index corresponding to the address index; a target index determining module, configured to determine a target address index from the data blocks based on the first range index; a query vector generation module, configured to generate an n-dimensional query vector based on the target address index and the n address indexes; and a query result determining module, configured to determine a query result from the n pieces of data based on the n-dimensional query vector.

According to a sixth aspect, example implementations provide a numerical range query apparatus for privacy protection, used to perform range query on n pieces of data, where the n pieces of data correspond to n address indexes, a tree-structured database is used to store a data block, a data block of the data blocks includes an address index and a range index corresponding to the address index, the tree-structured database is split into a plurality of tree-structured database shards respectively stored in a plurality of storage devices, and the apparatus is deployed in any storage device and includes: a leaf node receiving module, configured to receive a first leaf node sent by a query device, the first leaf node being computed based on a first range index, and the first range index being determined based on a preset correspondence between m numerical range intervals and range indexes and a numerical range to be queried; a block shard reading module, configured to read, in an oblivious random access manner, several data block shards corresponding to the first leaf node from tree-structured database shards stored in the storage device; and a block shard sending module, configured to send the several data block shards to the query device, so that the query device constructs data blocks based on data block shards sent by several storage devices, and determines a query result from the n pieces of data based on an n-dimensional query vector, the n-dimensional query vector being generated based on a target address index and the n address indexes, and the target address index being determined from the data blocks based on the first range index.

According to a seventh aspect, example implementations provide a numerical range query apparatus for privacy protection, used to perform range query on n pieces of data, where the n pieces of data correspond to n address indexes, a piece of data in the n pieces of data is split into a plurality of data shards to obtain a plurality of shard groups each including n data shards, the plurality of shard groups are respectively stored in a plurality of storage devices, and the apparatus is deployed in any storage device and includes: a vector shard receiving module, configured to receive an n-dimensional query vector shard sent by a query device, the n-dimensional query vector shard being obtained through splitting from an n-dimensional query vector, the n-dimensional query vector being generated based on a target address index and the n address indexes, the target address index being determined from data blocks based on a first range index, the first range index being determined based on a preset correspondence between m numerical range intervals and a range index and a numerical range to be queried, and a data block of the data blocks including an address index and a range index corresponding to the address index; a result shard determining module, configured to determine a query result shard based on the n-dimensional query vector shard and n data shards stored by the storage device; and a result shard sending module, configured to send the query result shard to the query device, for the query device to construct a complete query result based on query result shards sent by storage devices.

According to an eighth aspect, example implementation provide a data index construction apparatus for privacy protection, including: a first index determining module, configured to determine n address indexes corresponding to n pieces of data, to obtain a first correspondence; a range interval construction module, configured to construct m numerical range intervals covering a numerical range of the n pieces of data; a second index determining module, configured to determine m range indexes corresponding to the m numerical range intervals, to obtain a second correspondence; a mapping relationship determining module, configured to separately map the n pieces of data to the m numerical range intervals to obtain a first mapping relationship; a two-index corresponding module, configured to determine address indexes respectively corresponding to the m range indexes based on the first mapping relationship, the first correspondence, and the second correspondence; and a data block storage module, configured to use an address index and a range index corresponding to the address index as a data block, compute a leaf node corresponding to the data block based on the range index, and store the data block into a tree-structured database based on the leaf node.

According to a ninth aspect, example implementations provide a computer readable storage medium that stores a computer program, and when the computer program is executed on a computer, the computer is caused to perform the method according to any one of the first aspect to the fourth aspect.

According to a tenth aspect, example implementations provide a computing device, including a memory and a processor, where the memory stores executable code, and when executing the executable code, the processor implements the method according to any one of the first aspect to the fourth aspect.

The technical solutions provided in example implementations of the specification provide dual indexes, where a first index is an address index, and a second index is a range index. There is no size relationship between the address index and the range index, and there is no size relationship between the address index and data. The address index and the range index are correspondingly stored as a data block in the tree-structured database. When range query is performed, a range index may be determined from a numerical range to be queried, and a target address index in a data block is located based on the range index in an oblivious random access manner, so that access mode protection can be performed on a process of obtaining the target address index. An n-dimensional feature vector is generated by using the target address index and n address indexes, and a query result is determined from n pieces of data by using the n-dimensional feature vector. In this process, an access mode can be well protected, thereby improving confidentiality in a range query process.

### DESCRIPTION OF THE DRAWINGS

To describe the technical solutions in the implementations of the present disclosure more clearly, the following is a brief introduction of the accompanying drawings for illustrating such technical solutions. Clearly, the accompanying drawings in the following description are merely some implementations of the present disclosure. A person of ordinary skill in the art may still derive other drawings from these accompanying drawings without creative efforts.

FIG. 1 is a schematic diagram illustrating an implementation scenario of an implementation disclosed in the present specification.

FIG. 2 is a schematic flowchart illustrating a data index construction method for privacy protection according to an implementation.

FIG. 3 is a schematic flowchart illustrating a numerical range query method for privacy protection according to an implementation.

FIG. 4 is a schematic diagram illustrating an implementation scenario of another implementation disclosed in the present specification.

FIG. 5 is a schematic flowchart illustrating another numerical range query method for privacy protection according to an implementation.

FIG. 6 is a schematic block diagram illustrating a numerical range query apparatus for privacy protection according to an implementation.

FIG. 7 is a schematic block diagram illustrating another numerical range query apparatus for privacy protection according to an implementation.

FIG. 8 is a schematic block diagram illustrating still another numerical range query apparatus for privacy protection according to an implementation.

FIG. 9 is a schematic block diagram illustrating a data index construction apparatus for privacy protection according to an implementation.

### DESCRIPTION OF IMPLEMENTATIONS

The following describes the solutions provided in this specification with reference to the accompanying drawings.

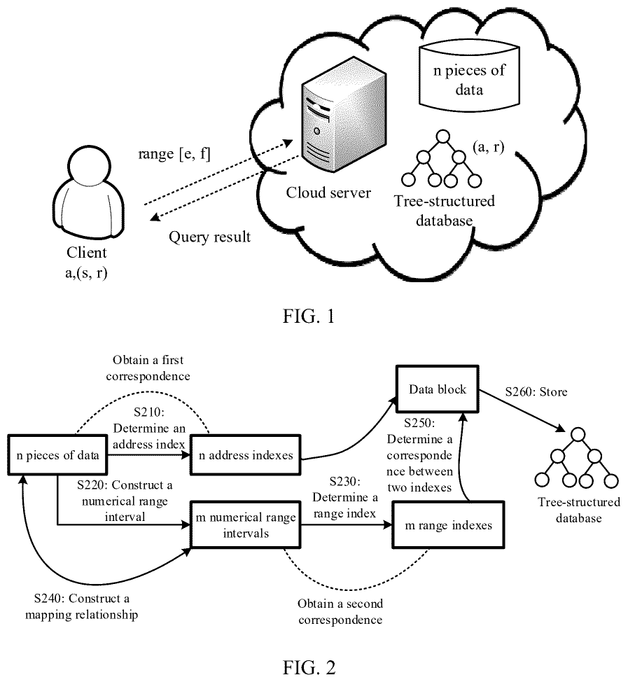

FIG. 1 is a schematic diagram illustrating an implementation scenario of an implementation disclosed in the present specification. The application scenario includes a client and a cloud server. The client stores all address indexes and a preset correspondence between m numerical range intervals s and a range index r. The cloud server side stores n pieces of data to be queried, and a tree-structured database that stores a plurality of data blocks. Each data block includes an address index a and a corresponding range index r, that is, (a, r), and data blocks that include the same range index r correspond to the same leaf node. A user queries, by using the client, the cloud server for data in a numerical range to be queried [e, f], to obtain a query result.

For example, the client may determine a leaf node based on the numerical range to be queried [e, f] and a correspondence between a numerical range interval s and a range index r, and request, from the cloud server, a data block corresponding to the leaf node, where the data block includes a required address index. After determining the address index, the client may determine a query vector, and request target data from the cloud server by using the query vector. The client may also send the numerical range to be queried [e and f] to the cloud server, and the cloud server determines the leaf node.

The n pieces of data are n pieces of discrete data, and belong to privacy data to be queried. The n pieces of data exist in a ciphertext manner in the cloud server. The n pieces of data may be attribute values of n object attributes. An object may be a user, a commodity, a store, or a transaction. An attribute may also be referred to as a feature. For example, the n pieces of data may be time values of registration time of n users. The n pieces of data may be attribute values of an attribute in n pieces of object data. One piece of data may contain attribute values of several attributes. Range query may be performed on an attribute value of an attribute. Therefore, the n pieces of data may be understood as attribute values of an attribute to be queried that includes only n objects.

The tree-structured database includes a plurality of nodes and a tree structure formed by the nodes. Data blocks may be stored on each node, and the plurality of nodes include a root node and a leaf node. The tree-structured database may be in the form of a binary tree or another tree.

In actual application, the user stores privacy data in the cloud server, and performs range query on the privacy data by using a computing service provided by the cloud server when required. However, when querying data, the user does not want the cloud server to know what data the user queries, that is, wants to keep a query behavior of the user confidential as far as possible.

To achieve confidentiality, order preserving encryption (OPE) is an optional solution. OPE is a special encryption solution in which a ciphertext is kept in a plaintext sequence. After the OPE solution is used to encrypt data and upload the data to the cloud server, the cloud server may obtain plaintext sequence information based on ciphertext sequence information. When performing range query, the user only needs to provide encrypted ciphertexts of two endpoints in a numerical range to be queried to the cloud server. Then, the cloud server may compare the encrypted ciphertexts of the interval endpoints provided by the user with ciphertexts of the original database, and then return, to the user, ciphertext data that meets a query requirement, including an identification (ID) of the ciphertext, for the user to decrypt. This solution can keep the query behavior of the user confidential to some extent. However, a malicious person may infer some information of the privacy data by using the ciphertexts of the interval endpoints and the document IDs of the ciphertexts that are sent a plurality of times between the user and the cloud server.

To improve confidentiality performance, so that a user does not disclose his access mode when accessing data on a cloud server, implementations of this specification provide a data index construction method for privacy protection and a numerical range query method for privacy protection, that is, dual indexes are constructed, and range query is performed on data by using the dual indexes. That is, this specification includes a data index construction phase and a range query phase. In the following description, the data index construction phase is first described, and the range query phase is then described. An implementation scenario of an implementation of the specification is not limited to the client and the cloud server shown in FIG. 1. The method of an implementation of the specification may be applied to any implementation scenario including a query device and a storage device.

The data index construction method provided in an implementation of the specification includes the following steps: Step S210: Determine n address indexes corresponding to n pieces of data, to obtain a first correspondence. Step S220: Construct m numerical range intervals covering a numerical range of the n pieces of data. Step S230: Determine m range indexes corresponding to the m numerical range intervals to obtain a second correspondence. Step S240: Separately map the n pieces of data to the m numerical range intervals to obtain a first mapping relationship. Step S250: Determine address indexes respectively corresponding to the m range indexes based on the first mapping relationship, the first correspondence, and the second correspondence. Step S260: Use an address index and a range index corresponding to the address index as a data block, compute a leaf node corresponding to the data block based on the range index, and store the data block into a tree-structured database in an oblivious random access manner.

The following describes an example implementation in detail with reference to FIG. 2. FIG. 2 is a schematic flowchart illustrating a data index construction method for privacy protection according to an implementation. The method may be performed by using an intermediate trusted device. For simplification, a case in which range query is performed on a plurality of attribute values is not considered herein, and based on an example implementation, an address index of each attribute value in the plurality of attribute values and an address range index table of the correspondence between a numerical range interval and a range index may be separately generated. In this case, range query may be performed on a plurality of different attribute values. Therefore, the following example considers only a case in which range query is performed on one attribute value. In the data index construction phase, the intermediate trusted device can obtain unencrypted numeric values of the n pieces of data, that is, plaintext data, so as to construct an index based on the numeric values of the n pieces of data. n is an integer greater than 0. Step S210 and step S220 are not sequentially performed, and step S230 and step S240 are not sequentially performed.

In step S210, n address indexes a corresponding to the n pieces of data are determined to obtain the first correspondence. Data are in a one-to-one correspondence with address indexes, to ensure that each piece of data has a unique address index a, and the address index a is used to represent corresponding data. The address index a may be represented by a number or a letter. When the n address indexes a corresponding to the n pieces of data are determined, the n address indexes a may be generated in a preset manner. Generally, there is no rule of any size relationship between the n pieces of data, and there is no numerical correspondence between the generated n address indexes and the n pieces of data. For example, Table 1 lists a correspondence between the n pieces of data and the n address indexes a, which is referred to as an address index table.

TABLE 1

| | Video | Video | | | |
|---|---|---|---|---|---|
| Address | playback | forwarding | Video likes | | Video |
| index | amount | amount | amount | . . . | upload time |
| 1 | x₁ | y₁ | z₁ | . . . | h₁ |
| 2 | x₂ | y₂ | z₂ | . . . | h₂ |
| 3 | x₃ | y₃ | z₃ | . . . | h₃ |
| . . . | . . . | . . . | . . . | . . . | . . . |
| n | xₙ | yₙ | zₙ | . . . | hₙ |

In Table 1, a video playback amount of an attribute value is used as an example, and address indexes 1, 2, . . . , and n are respectively established for the data one by one according to values of the video playback amount x₁, x₂, . . . , and xₙ, so as to ensure that each data has a unique address index a, so as to obtain an address index table R. Each row in Table 1 is privacy data of one object. The determined n pieces of data are arranged in the same order as corresponding n address indexes.

In step S220, the m numerical range intervals covering the numerical range of the n pieces of data are constructed. m may be a specified integer value greater than 0. m may be greater than n, or may be less than n, or may be determined based on n. The m numerical range intervals may be consecutive or inconsecutive, but a total range of the m numerical range intervals needs to cover all values of the n pieces of data.

In an implementation, step S220 may be constructing the m numerical range intervals based on a maximum value and a minimum value of the n pieces of data. Specifically, the maximum value x_{high} and the minimum value x_{low} may be determined from the values of the n pieces of data. Based on the maximum value x_{high} and the minimum value x_{low}, an interval length range1 used to construct a numerical range interval is determined. Based on the interval length range1, the m numerical range intervals are constructed. The interval length range1 may be public data.

A plurality of solutions may be included when the interval length range1 is determined. In a manner, a difference between the maximum value x_{high} and the minimum value x_{low} is computed, an average value of the difference is obtained by using n, and the interval length range1 is determined based on the average value. For example, the difference is directly divided by n, or weighted and divided by n, to obtain the interval length range1, that is, range1=(x_{high}−x_{low})/n. Alternatively, n is not used, and the interval length range1 is obtained by dividing the difference by a preset value.

When the interval length range1 is obtained by dividing the difference by n, the m numerical range intervals may be successively determined starting from the minimum value x_{low} and using the interval length range1 as a step. In this case, m may be set to a value after n is increased by 1, that is, m=n+1. When the interval length range1 is determined in another manner, the m numerical range intervals may be constructed based on the interval length range1 in a corresponding manner.

For example, based on the attribute values x₁, x₂, . . . , and xₙ, the following n+1 left-closed and right-opened numerical range intervals may be obtained: [x_{low}, x_{low}+range1), [x_{low}+range1, x_{low}+2·range1), . . . , and [x_{low}+n·range1, x_{low}+(n+1)·range1). It is assumed that a range index corresponding to an interval [x_{low}+j·range1, x_{low}+(j+1)·range1) is r, 0≤j≤n, and j is an integer.

In step S230, the m range indexes r corresponding to the m numerical range intervals are determined to obtain the second correspondence. The numerical range intervals are in a one-to-one correspondence with the range indexes r to ensure that each numerical range interval r has a unique range index, and the range index r is used to represent a corresponding numerical range interval. The range index r may be represented by a number or a letter. When the m range indexes r are determined, the m range indexes r may be generated in a preset manner.

In step S240, the n pieces of data are respectively mapped to the m numerical range intervals to obtain the first mapping relationship.

In step S250, the address indexes a respectively corresponding to the m range indexes r are determined based on the first mapping relationship, the first correspondence, and the second correspondence. In actual application, the foregoing steps S240 and S250 may be combined into one step for execution.

In step S260, an address index a and a range index r corresponding to the address index a are used as a data block, a leaf node corresponding to the data block is computed based on the range index, and the data block is stored in the tree-structured database.

Because the m numerical range intervals can cover all the values of the n pieces of data, each piece of data may be mapped to a numerical range interval. The n pieces of data are not in a one-to-one correspondence with the m numerical range intervals. One piece of data corresponds to one numerical range interval, but one numerical range interval may correspond to one or more pieces of data. The first mapping relationship can blur numerical ranges of the n pieces of data. Using the first mapping relationship as a bridge, a correspondence between a range index and an address index can be established. Table 2 lists an example of a correspondence between a range index r, a numerical range interval, and an address index a.

TABLE 2

| | | Address |
|---|---|---|
| Range index r | Range interval | index a |
| r₀ | [x_{low}, x_{low} + range1) | 1 |
| | | 2 |
| | | 8 |
| r₁ | [x_{low} + range1, x_{low} + 2 · range1) | 3 |
| | | 4 |
| | | 5 |
| . . . | . . . | . . . |
| rₙ | [x_{low} + n · range1, x_{low} + (n + 1) · range1) | * |
| | | * |
| | | 7 |

In Table 2, the first column on the left is a range index r, the middle column is a specific numerical range interval corresponding to the range index r, and the first column on the right is an address index a.

It can be learned that there is no one-to-one correspondence between the n address indexes a and the m range indexes r. One address index corresponds to one range index, and one range index may correspond to zero, one, or more address indexes, that is, range indexes corresponding to different address indexes may be repeated. The range index r is used to represent the address index a, which is a fuzzy representation and can protect the address index a.

To improve ambiguity of a correspondence between a range index and an address index, a plurality of address indexes are protected in an access mode, and the correspondence between the m range indexes and the n address indexes determined based on the first mapping relationship, the first correspondence, and the second correspondence may be used as an initial correspondence. When a quantity of address indexes corresponding to a range index r in the initial correspondence is less than a preset quantity of k, several invalid address indexes are filled, so that a quantity of address indexes a corresponding to the range index r reaches k.

k is a positive integer, and k is not less than a maximum value of the quantity of address indexes corresponding to the range index in the initial correspondence. That is, a quantity of address indexes corresponding to each range index in the initial correspondence may be counted, a maximum value is determined from a plurality of quantities, and the value of k is determined based on the maximum value. For example, k may be set to the maximum value, or a value larger than the maximum value. In addition, k may be generally set to a value less than or equal to n, which can reduce data redundancy.

In Table 2, k is set to 3, that is, each range index r corresponds to three address indexes. When a quantity of address indexes a corresponding to a range index is less than 3, invalid address indexes are filled, and * is used in Table 3 to represent an invalid address index. A correspondence between a range index and an address index may be obtained by removing a range interval in the middle column of Table 2. See Table 3.

TABLE 3

| Range index r | Address index a |
|---|---|
| r₀ | 1 |
| | 2 |
| | 8 |
| r₁ | 3 |
| | 4 |
| | 5 |
| . . . | . . . |
| rₙ | * |
| | * |
| | 7 |

Each range index r in Table 2 corresponds to three address indexes.

The correspondence between a range index and an address index is filled with invalid address indexes, so that each range index is corresponding to the same quantity of address indexes, and an indistinctive correspondence is constructed, so that a quantity of data blocks corresponding to each leaf node is not different, thereby protecting an access mode.

In step S260, one address index a and one range index r are used to construct one data block. In this way, n data blocks may be obtained, and the n data blocks are stored in the tree-structured database. Generally, the tree-structured database is stored in a storage device such as a cloud server, and the intermediate trusted device may store a data block into the tree-structured database based on a leaf node in an oblivious random access manner in the data index construction phase. The intermediate trusted device may further encrypt the data block, and store the encrypted data block into the tree-structured database. That is, the data block in the tree-structured database may be stored in a cryptographic state. For example, the intermediate trusted device may encrypt the data block by using a public key. In subsequent query, a query device decrypts the data block by using a corresponding private key.

The oblivious random access manner is based on an oblivious random access machine (ORAM). This access mode allows the user to access his data on the cloud server without leaking his access mode.

The tree-structured database may be a binary tree or another tree structure. The tree-structured database includes a plurality of nodes ranging from a root node to a leaf node, and each node is configured to store data blocks. In the ORAM manner, each data block is stored in a node included in a path between a leaf node and the root node, and each data block is stored based on a corresponding leaf node.

In step S260, when the leaf node corresponding to the data block is computed based on the range index r, the leaf node corresponding to the data block may be computed based on the range index r and a query order by using a hash function. For example, for a data block d=(r, a), a hash value T_{H}(rᵢ, nᵣ)=Lᵢ may be computed by using a hash function, and the hash value is used as an identifier of the leaf node Lᵢ. T_{H} is the hash function, and nᵣ is the query order, that is, a global server range query order, starting from 0. The output leaf node L belongs to {0, 1, 2^{H}−1}.

In this implementation, the intermediate trusted device determines the n address indexes corresponding to the n pieces of data, determines the m numerical range intervals and the corresponding m range indexes, and determines the correspondence between the m range indexes and the n address indexes. The n address indexes, the m numerical range ranges, and the corresponding m range indexes may be disclosed to the query device (for example, the client of the user). The intermediate trusted device may further store the tree-structured database and the n pieces of data in a cryptographic manner into the storage device. When completing index construction, the intermediate trusted device goes offline, and no longer participates in the subsequent query phase.

Subsequently, the storage device may perform range query on the n pieces of data in response to a request of the query device. The following describes the range query phase. Corresponding to the implementation in FIG. 2, an implementation of the specification further provides a numerical range query method for privacy protection, so as to perform range query on n pieces of data, where the n pieces of data correspond to n address indexes. The method includes the following steps: Step S310: Determine a first range index corresponding to a numerical range to be queried based on a preset correspondence between m numerical range intervals and range indexes. Step S320: compute a corresponding first leaf node based on the first range index. Step S330: Read, in an oblivious random access manner, data blocks corresponding to the first leaf node from a tree-structured database, a data block of the data blocks including an address index and a range index corresponding to the address index. Step S340: Determine a target address index from the data blocks based on the first range index. Step S350: Generate an n-dimensional query vector based on the target address index and the n address indexes. Step S360: Determine a query result from the n pieces of data based on the n-dimensional query vector.

In this implementation, a range index may be determined by using a numerical range to be queried, and a leaf node may be determined by using the range index. A data block may be read from a tree-structured database based on the leaf node in an oblivious random access manner, and a target address index is locked from the data block, but an access mode in a process of reading the data block is not disclosed. The n-dimensional query vector also well masks value information of data to be queried. Therefore, a process of obtaining a query result based on the query vector does not disclose information about the numerical range to be queried.

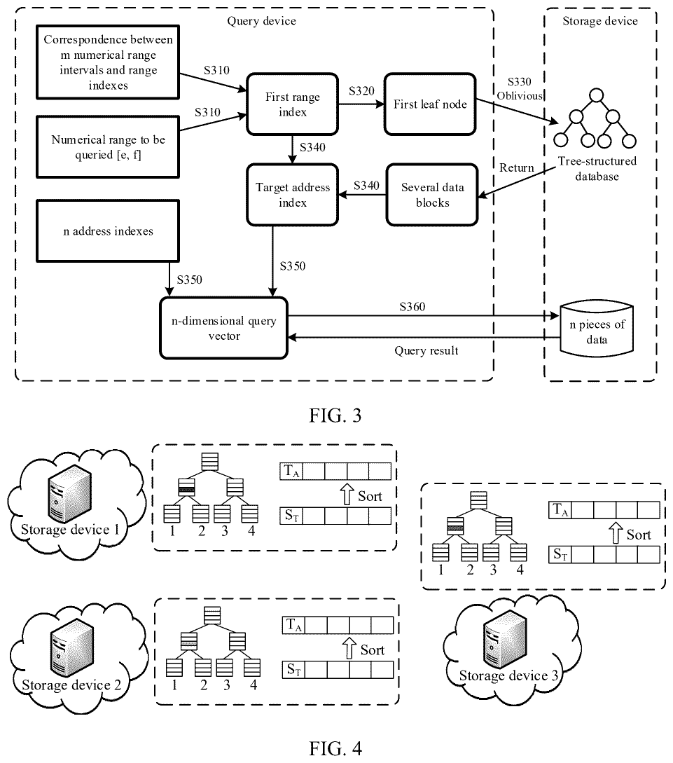

The following describes an implementation in detail with reference to FIG. 3. FIG. 3 is a schematic flowchart illustrating a numerical range query method for privacy protection according to an implementation. The method may be performed by a query device and a storage device. The query device and the storage device may be in a relationship between a client and a cloud server, or may be devices in another scenario. The query device has a correspondence between m numerical range intervals and range indexes, n address indexes, and a numerical range to be queried triggered by a user to the query device. The storage device stores a cryptographic tree-structured database and n pieces of cryptographic data. The tree-structured database and the n pieces of data may be stored in different storage devices, or may be stored in the same storage device.

In step S310, after the query device obtains a numerical range to be queried [e, f], a first range index r1 corresponding to the numerical range to be queried [e, f] may be determined based on a preset correspondence between the m numerical range intervals and range indexes. Specifically, the numerical range to be queried [e, f] and the m numerical range intervals may be mapped, and a range index corresponding to the mapped numerical range interval is used as the first range index r1.

For example, a user may send a query request to the query device to request to query video data whose video playback amount is within [0, 6000]. There may be one or more first range indexes r1.

In step S320, the query device computes the corresponding first leaf node L1 based on the first range index r1. Specifically, the first leaf node L1 may be computed based on the first range index r1 by using a hash function. Different first range indexes correspond to different first leaf nodes. When there are a plurality of first range indexes r1, there are a plurality of first leaf nodes L1.

When the first leaf node L1 is computed, the corresponding first leaf node L1 may also be computed based on the first range index r1 and a current query order. During example computing, a hash value may be computed based on the first range index r1 and the current query order by using the hash function, and the hash value is used as an identifier of the first leaf node. Introducing the query order into the computing of the leaf node enables each global query to update the leaf node, avoiding a malicious person from inferring information based on the leaf node. After query is completed, the current query order is further updated to obtain an updated query order, a corresponding second leaf node is computed based on the first range index r1 and the updated query order, and the second leaf node is sent to the storage device. In this way, the storage device may receive the second leaf node sent by the query device, and backfill a queried data block based on the second leaf node, so that each query for the data block is closer to random query, thereby improving confidentiality of the data block.

In step S330, the query device reads, in an oblivious random access machine ORAM manner, data blocks corresponding to the first leaf node L1 from the tree-structured database. The data block includes an address index a and a corresponding range index r. The query device may send the first leaf node L1 to the storage device. After receiving the first leaf node L1, the storage device may read all data blocks on a path from the first leaf node L1 to a root node from the tree-structured database, and send the data blocks to the query device. The data block stored in the tree-structured database may be encrypted data. When receiving data blocks, the query device may decrypt the data blocks.

Specifically, the ORAM may be implemented by using a tree ORAM, a path ORAM, or a multi-path oblivious random access machine (OBI). Specifically, a process in which the ORAM reads, from the tree-structured database, the data blocks corresponding to the first leaf node L1 is not described again, and may be implemented with reference to the prior art.

In step S340, the query device determines the target address index a_{target} from the data blocks based on the first range index r1. The data blocks include all data blocks whose range index is the first range index r1, and also include a data block with another range index. The query device may search for the target data block including the first range index r1 from the data blocks, and use the address index in the target data block as the target address index a_{target}.

In step S350, the query device may generate the n-dimensional query vector based on the target address index and the n address indexes.

In step S360, the query device may determine the query result from the n pieces of data stored in the storage device based on the n-dimensional query vector.

The n-dimensional query vector is used to select target data from the n pieces of data. It should be noted that the n pieces of data stored in the storage device are encrypted data.

When the n-dimensional query vector is generated, the n-dimensional vector corresponding to locations of the n address indexes may be constructed, an element at a location of the target address index in the n-dimensional vector may be set to a preset value that is not 0, and another location may be set to 0, to obtain the query vector. The preset value may be, for example, an integer such as 1, 2, 3, or 4, or a non-integer. A manner of generating the n-dimensional query vector may further include another manner.

The query device may send the n-dimensional query vector to the storage device. After receiving the n-dimensional query vector sent by the query device, the storage device determines the query result from the n pieces of data based on the n-dimensional query vector, and sends the query result to the query device. The query device may encrypt the n-dimensional query vector by using an encryption algorithm that meets additive homomorphism and multiplication homomorphism, and send an encrypted result to the storage device.

The storage device may obtain an n-dimensional query result based on a product of the n-dimensional query vector and the same-location element of a data vector, the data vector including the n pieces of data. Because the location element of the target address index in the n-dimensional query vector is 1, and another location is 0, the n-dimensional query vector is multiplied by the same-location element of the data vector, required data may be selected from the n pieces of data, and not required data are changed to 0. In this way, the obtained n-dimensional query result includes only required target data, and the not required data have a value of 0. During each query, the storage device sends the n-dimensional query result to the query device. Regardless of how many elements in the n-dimensional query vector are 1, or regardless of whether a quantity of data that need to be queried is large or small, results returned by the storage device are n-dimensional query vectors. A malicious person cannot infer data from each n-dimensional query result, and therefore, a query process can be protected in an access mode.

When each piece of data in the n pieces of data and each element in the n-dimensional query vector are encrypted by using an encryption algorithm that meets additive homomorphism and multiplication homomorphism, multiplying the n-dimensional query vector by the same-location element of the data vector is equivalent to multiplying the n-dimensional query vector in a plaintext by the same-location element of the data vector in a plaintext, and then encrypting the product. Therefore, when obtaining the encrypted n-dimensional query result, the query device decrypts the n-dimensional query result to obtain the plaintext.

It should be noted herein that the storage device may store a correspondence between the n pieces of data and the n address indexes at the same time, or may store only the n pieces of data but not the n address indexes. However, the n address indexes owned by the query device and the n pieces of data owned by the storage device are arranged in the same order.

FIG. 4 is a schematic diagram illustrating an implementation scenario of another implementation disclosed in the present specification. The implementation scenario includes a storage device 1, a storage device 2, and a storage device 3. Each storage device includes a tree-structured database shard, a storage area S_{T}, and a sorting area T_{A}. The tree-structured database in each of the three storage devices is not a complete tree-structured database, but a shard of the complete tree-structured database. tree-structured databases in different storage devices have exactly the same tree structure (for example, having the same leaf nodes 1, 2, 3, and 4), and exactly the same quantity of data blocks, and any node of any tree-structured database shard contains a shard of the same data block. For example, red, yellow, and blue blocks at the same location in the three tree-structured database shards represent different shards of the same data block.

In this implementation, there are a plurality of storage devices, and in the data index construction phase, for example, in step S260 in the implementation shown in FIG. 2, after all the data blocks are stored into the tree-structured database, the tree-structured database may be split into a plurality of tree-structured database shards, which are respectively stored in a plurality of storage devices. During splitting, a data block of each node in the tree-structured database needs to be sharded. A tree structure of each tree-structured database shard is exactly the same, and each node stores a shard of a data block. For example, for tree-structured database shards 1, 2, and 3 stored in different storage devices 1, 2, and 3, different shards of the same data block are stored at the same location of the same node of the tree-structured database shards 1, 2, and 3, and these shards can be used to reconstruct a complete data block.

When a tree-structured database is split, actually each data block in each node in the tree-structured database is split. During splitting, a secret sharing algorithm can be used for splitting. The secret sharing algorithm may be, for example, replicated secret sharing (RSS) or another type of secret sharing. The secret sharing algorithm meets additive homomorphism and multiplication homomorphism that are involved by a plurality of parties. The secret sharing algorithm is used to store a complete tree-structured database in a shard form into a plurality of storage devices, so that each storage device cannot use a tree-structured database shard owned by the storage device to obtain privacy data. Therefore, snooping by a malicious storage device can be avoided.

A plurality of tree-structured database shards obtained through splitting may be respectively stored in the plurality of storage devices, and each storage device stores one tree-structured database shard.

To avoid a case in which a storage device is faulty and fails to query a data block, a 2-out-of-3 secret sharing algorithm may further be used during splitting, so that each storage device stores more than one shard. For example, for a tree-structured database D, D may be split into shards [D]₁, [D]₂, and [D]₃ by using the replicated secret sharing algorithm, and distributed to the storage devices 1, 2, and 3, where each storage device stores two shards. That is, a storage device i stores [S]ᵢ=([D]ᵢ, [D]ᵢ₊₁), i∈{1, 2, 3}. For example:
the storage device 1 stores: [S]₁=([D]₁, [D]₂);
the storage device 2 stores: [S]₂=([D]₂, [D]₃); and
the storage device 3 stores: [S]₃=([D]₃, [D]₁).

In this way, one storage device is allowed to fail, and only two storage devices are required to restore complete data. In this specification, “[D]” is used as a shard symbol of the data D, and other data shards are similar thereto.

In the range query stage, to facilitate each storage device to read data from a tree-structured database shard, in specific implementation, each storage device may further set a storage area S_{T} and a sorting area T_{A}. The storage area S_{T} is used to store a database shard read from the tree-structured database shard. After each query, a tree-structured database shard needs to be backfilled, that is, a leaf node of a data block is updated, and data block shards are resorted and then re-stored into the tree-structured database shard, thereby improving security. The sorting area T_{A} is used to store sorted data blocks.

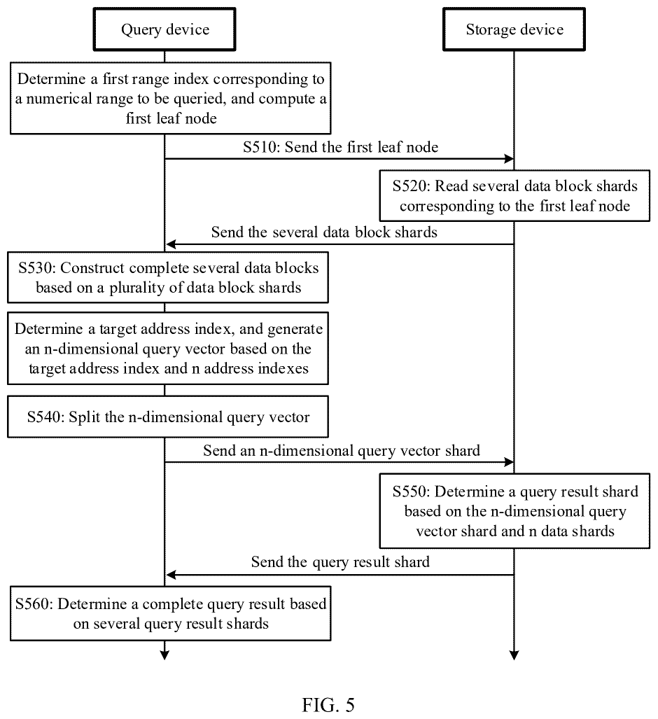

FIG. 5 is a schematic flowchart illustrating another numerical range query method for privacy protection according to an implementation. An implementation is obtained based on the implementation in FIG. 3. Only differences from the implementation in FIG. 3 are described in detail herein. For the same content, references may be made to the implementation in FIG. 3, and details are not described again.

In an implementation, a query device determines, based on a preset correspondence between m numerical range intervals and range indexes, a first range index r1 corresponding to a numerical range to be queried [e, f], and computes a corresponding first leaf node L1 based on the first range index r1, which is the same as that in steps S310 and S320.

Corresponding to step S330 in FIG. 3, in an implementation, an objective of obtaining data blocks corresponding to the first leaf node L1 may be implemented according to the following steps S510-S530.

Step S510: The query device separately sends the first leaf node L1 to several storage devices, and the several storage devices separately receive the first leaf node L1 sent by the query device.

When a tree-structured database is split by using a 2-out-of-3 secret sharing algorithm, that is, each storage device stores more than one tree-structured database shard, the query device may send the first leaf node L1 to only some storage devices.

Step S520: Any storage device reads, in an oblivious random access ORAM manner, several data block shards corresponding to the first leaf node L1 from a tree-structured database shard of the storage device, and sends the several data block shards to the query device. Each storage device performs this operation, and sends, to the query device, several data block shards read by the storage device. The query device receives several data block shards separately sent by several storage devices.

The storage device may store, into the storage area S_{T}, several data block shards that are corresponding to the first leaf node and that are read from the tree-structured database shard.

In this step, each storage device reads several data block shards from a tree-structured database shard of the storage device in the same manner. For example, the storage device 1 reads a first shard of a data block d(r₁, a₁), a first shard of a data block d(r₂, a₂), and a first shard of a d(r₃, a₃); the storage device 2 reads a second shard of the data block d(r₁, a₁), a second shard of the data block d(r₂, a₂), and a second shard of the data block d(r₃, a₃); and the storage device 3 reads a third shard of the data block d(r₁, a₁), a third shard of the data block d(r₂, a₂), and a third shard of the data block d(r₃, a₃). In this example, a specific data block is listed for clear description. Actually, data blocks exist in a cryptographic state in a shard form, and a storage device does not know which complete data block to which a shard belongs.

Step S530: The query device constructs complete data blocks based on a plurality of data block shards.

The query device knows a sequence of each storage device and a sequence of data block shards stored in each storage device in the data index construction phase. The query device may construct the plurality of data block shards with reference to the sequence, to restore complete data blocks.

When the plurality of data block shards are restored to a complete data block, the data block shards may be added based on a secret sharing algorithm, or an exclusive OR operation is performed, so that the complete data block can be restored. A specific restore operation is related to the selected secret sharing algorithm.

In an implementation, a tree-structured database shard is stored in different storage devices, so as to implement shard secrecy storage for data of a data block.

After obtaining the complete data blocks, the query device may determine a target address index a from the data blocks based on the first range index r1, and generate an n-dimensional query vector based on the target address index and the n address indexes. These steps are the same as those in S340 and S350 in FIG. 3, and are not described again.

To improve privacy and security of n pieces of data, an implementation may further split any one of the n pieces of data to obtain w data shards. The n pieces of data may be split to obtain w shard groups each formed by n data shards, that is, obtain w shard groups, where each shard group includes n data shards. A plurality of shard groups are respectively stored in a plurality of storage devices. w is a quantity of storage devices, and is a positive integer.

A secret sharing algorithm may be used to split data. The w shard groups obtained through splitting may be respectively stored into w storage devices, that is, each storage device stores one shard group.

To avoid a case in which privacy data cannot be queried due to a failure of a storage device, the 2-out-of-3 secret sharing algorithm may further be used during splitting, so that each storage device stores more than one shard group. For example, a data group R formed by n pieces of data may be secretly shared by using the replicated secret sharing algorithm, to obtain cryptographic shard groups [R]₁, [R]₂, and [R]₃, which are respectively distributed to the storage devices 1, 2, and 3 for storage. Each storage device stores two shares, that is, the storage device 1 stores ([R]₁, [R]₂), the storage device 2 stores ([R]₂, [R]₃), and the storage device 3 stores ([R]₃, [R]₁), that is, a storage device i stores ([R]ᵢ, [R]ᵢ₊₁), i∈{1, 2, 3}. When i=3, i+1 is 1.

Herein, R may also be a correspondence between n pieces of data and n address indexes. That is, when data are split, a corresponding address index may be split and stored together with a data shard.

Corresponding to step S360 in FIG. 3, in an implementation, an objective of obtaining a query result may be implemented according to the following steps S540-S560.

Step S540: The storage device splits an n-dimensional query vector into a plurality of n-dimensional query vector shards, and correspondingly sends the plurality of n-dimensional query vector shards to the plurality of storage devices separately. The plurality of storage devices separately receive the n-dimensional query vector shards sent by the query device.

The storage device may split the n-dimensional query vector by using the secret sharing algorithm, and each obtained query vector shard is still n-dimensional.

Step S550: Any storage device determines a query result shard based on the n-dimensional query vector shard and n data shards stored in the storage device, and sends the query result shard to the query device. Another storage device also performs this step to determine a query result shard, and sends the query result shard to the query device. The query device receives query result shards sent by several storage devices.

Specifically, the storage device may obtain the query result shard based on a product of the n-dimensional query vector shard and the same-location element of a data vector shard, and the query result shard is also n-dimensional. The data vector shard includes n data shards.

Shard data obtained through secret sharing meets such an operation: After a query result shard obtained by performing a product operation on a query vector shard and a data shard is restored to a complete query result, it is equal to a query result obtained after the complete query result is multiplied by complete data.

Step S560: The query device determines a complete query result based on the received several query result shards.

The query device knows a sequence of each storage device and a sequence in which each shard group is sent to each storage device after the n pieces of data are split into data shards. The query device may construct a plurality of query result shards with reference to the sequence to restore a complete query result.

In an example, the storage device is implemented as a server, and the query device may be one of a plurality of servers, for example, represented by a server i. The server i performs secret sharing on a query vector q to obtain the following query vector shards:

$${[ q ]}_{j} = ( {[ {q}_{1} ]}_{i} , … , {[ {q}_{n} ]}_{j} ) , j ∈ \{ 1 , 2 , 3 \}$$

The server i sends ([q]ᵢ₊₁, [q]ᵢ₊₂) to a server i+1, and sends ([q]ᵢ₋₁, [q]ᵢ) to a server i−1. For ease of description, when i∈{1, 2, 3}, i+1 and i−1 are respectively corresponding to a number before and a number after i, that is, when i=1, i−1=3; and when i=3, i+1=1. In the following, i+2 is used to represent a number before i+1, which is the same as i−1.

The server i+1 computes the following content:

$${[ B ]}_{i + 1} = {[ q ]}_{i + 1} \cdot {[ R ]}_{i + 1} \\ {[ B ]}_{i + 2} = {[ q ]}_{i + 2} \cdot {[ R ]}_{i + 2}$$

sends [B]ᵢ₊₁ and [B]ᵢ₊₂ to the server i.

Similarly, the server i−1 computes the following content:

$${[ B ]}_{i - 1} = {[ q ]}_{i - 1} \cdot {[ R ]}_{i - 1} \\ {[ B ]}_{i} = {[ q ]}_{i} \cdot {[ R ]}_{i}$$

sends [B]ᵢ₋₁ and [B]ᵢ to the server i. By running the secret sharing algorithm, the server i may restore the complete query result based on the obtained cryptographic query result shards [B]ᵢ, where i∈{1, 2, 3}. When a query vector is constructed, and a vector location corresponding to the target address index is set to a value other than 1, the query result needs to be divided by the value to obtain a final query result. When the vector location corresponding to the target address index is set to 1, the division operation does not need to be performed.

In an implementation, the n pieces of data are split into a plurality of data shards through secret sharing, and are separately stored in different storage devices. An operation that is related to a data shard and that is performed by any storage device in response to a query request does not disclose privacy data therein. Therefore, shard storage data improve security during data query.

The following further describes an execution process of step S520. During data query, a plurality of leaf nodes may be simultaneously queried. To improve processing efficiency, the storage device may use a multi-path oblivious random access machine (OBI). The OBI is a multi-path ORAM based on the path ORAM. A large quantity of data block shards are read from a tree-structured database shard by accessing a plurality of paths, and processing efficiency is relatively high. The OBI hides an access mode of data by reading a large quantity of data blocks.

To protect privacy of the data, after the data block is read from the storage device, multi-path backfill obfuscation eviction may be further performed. The query device may update a current query order to obtain an updated query order, compute a corresponding second leaf node L2 based on the first range index r1 and the updated query order, and separately send the second leaf node L2 to a plurality of storage devices.

Any storage device may receive the second leaf node L2 sent by the query device, and perform, based on the second leaf node L2, sorting on several data block shards by interacting with another storage device, to obtain sorted data block shards, and each storage device performs same sorting on several data block shards of the storage device. Then, each storage device backfills sorted data block shards into a tree-structured database shard.

When updating the current query order nᵣ, the query device may, for example, increase the query order nᵣ by 1 to obtain the updated query order nᵣ′=nᵣ+1. The second leaf node L2 is computed in the same manner as the first leaf node L1.

A plurality of storage devices may sort cryptographic data in the storage area S_{T} by using a trusted-environment-based cryptographic computing (TECC) algorithm or another similar secure sorting algorithm through mutual interaction according to a size of a leaf node corresponding to the data, and store sorted data block shards into the sorting area T_{A}, thereby implementing joint sorting of a plurality of data block shards, so that shards of the same data block in each storage device are at the same location, that is, each storage device obtains same data block shard sorting.

For example, sorting obtained in the storage device 1 is: a first shard of a data block d(r₂, a₂), a first shard of a data block d(r₁, a₁), and a first shard of d(r₃, a₃). Sorting obtained in the storage device 2 is: a second shard of the data block d(r₂, a₂), a second shard of the data block d(r₁, a₁), and a second shard of d(r₃, a₃). Sorting obtained in the storage device 3 is: a third shard of the data block d(r₂, a₂), a third shard of the data block d(r₁, a₁), and a third shard of d(r₃, a₃). Sorting in all of the storage devices 1, 2, and 3 is: the data block d(r₂, a₂), d(r₁, a₁), and d(r₃, a₃).

Then, the storage device may backfill the data blocks in the sorting area by using the OBI-based backfill algorithm, so as to update the data block shards in the tree-structured database shards, and hide the access mode in this manner.

In the foregoing implementation, the storage device may operate the cryptographic data in a trusted execution environment (TEE), so as to improve data security. A function undertaken by each storage device may be divided into a plurality of computing tasks. A function of one storage device may be performed by one TEE partition cluster, and one TEE partition cluster includes a plurality of TEEs. The plurality of TEEs run in a high-speed network, that is, an internal network, and are adapted to a trusted-environment-based cryptographic computing system.

A plurality of storage devices may run in a wide area network (external network) or a local area network (internal network). When the three storage devices run in an internal network and the query device runs in the internal network, remote interaction with a client does not need to be performed during query, query performance is not limited by bandwidth, and query efficiency is high.

When shard data stored in a plurality of storage devices are obtained by using the 2-out-of-3 replicated secret sharing solution, one malicious storage device can be resisted, and normal running can be performed when one storage device is down. Therefore, robustness is good.

In the foregoing implementation, a client may not be required, and only one intermediate trusted party is required to perform initialization, so as to be responsible for a global initialization process. Subsequently, this intermediate trusted party may go offline. This intermediate trusted party is assumed to be reasonable in reality, because in reality, a third-party organization such as a demand party or an enterprise always needs to set up a data platform. Therefore, the intermediate party may be a third-party organization such as a user or an organization to protect data privacy of the user.

In the foregoing implementation, secret sharing is performed on the storage area and the sorting area, and storage overheads of one client are allocated to three storage devices, which not only reduces storage pressure, but also ensures data confidentiality, because a storage device side stores a secret sharing share, not a data plaintext.

In the data index construction phase, that is, in the global initialization process, a path oblivious random access machine algorithm Path ORAM may be used to construct a tree-structured database.

In the backfill process after query, multi-path backfill algorithms KNNEA and PBEA in the multi-path oblivious random access machine algorithm OBI may be used. The Range ORAM used in the foregoing implementation mainly includes two algorithms Access and Evict.

Evict is a multi-path backfill algorithm that is used to backfill an oblivious random access machine in a cryptographic range with a large quantity of cryptographic data blocks in the storage area. The core idea is to divide a leaf node range into a set of fixed-size partitions with a size of a power of 2 (for example, 65536). A cryptographic data block may then be inserted into a corresponding partition according to the leaf node. Next, Evict_{KNNEA} can be used to process each partition to achieve a batch backfill effect.

Evict includes two phases. In the first phase, Evict backfills each non-empty partition with most of the cryptographic data blocks by batch processing. Therefore, computational complexity of O(n) is avoided, because there is no need for linear scanning of the entire storage area and backfilling the cryptographic data blocks one by one. In the second phase, Evict further invokes Evict_{KNNEA} to backfill remaining cryptographic data blocks in the storage area. Because a quantity of cryptographic data blocks stored in the storage area after backfilling of all partitions is relatively small, processing a remaining result by using Evict_{KNNEA} is highly efficient. For each partition, Evict invokes Evict_{KNNEA*} to evict a cryptographic data block to a corresponding path of the oblivious random access machine in the cryptographic range. The difference between Evict_{KNNEA*} and Evict_{KNNEA} is that Evict_{KNNEA} attempts to evict cryptographic data blocks of the entire storage area to paths of all leaf node sets from leaf nodes to the root node, and Evict_{KNNEA*} attempts to evict a cryptographic data block of a partition to a path of a partition. For a specific backfill process, refer to the related prior art.

In this specification, “first” in words such as a first leaf node and a first range index, and a corresponding “second” (if present) in this specification are merely for distinguishing and easy description, and do not have any limiting significance.

In this specification, the storage device and the query device may be implemented by using any apparatus, device, platform, device cluster, or the like that has a computing and processing capability.

The foregoing content describes an example implementation of this specification, and another implementation is within the scope of the appended claims. In some cases, actions or steps described in the claims may be performed in a sequence different from that in some implementations and desired results can still be achieved. In addition, the process depicted in the accompanying drawings does not necessarily follow a particular execution order as shown to achieve the desired results. In some implementations, multi-tasking and concurrent processing are feasible or may be advantageous.

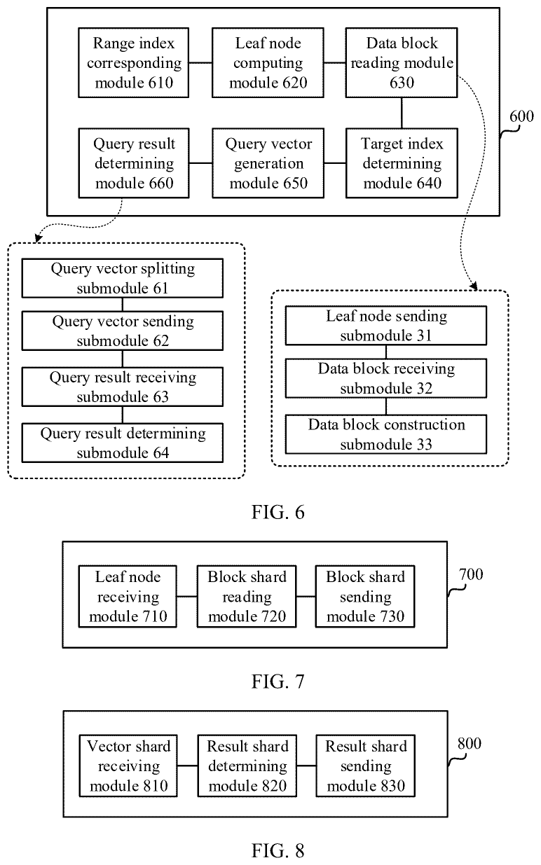

FIG. 6 is a schematic block diagram illustrating a numerical range query apparatus for privacy protection according to an implementation. The apparatus 600 is configured to perform range query on n pieces of data, where the n pieces of data correspond to n address indexes. An apparatus implementation corresponds to the method implementation shown in FIG. 3. The apparatus 600 includes: a range index corresponding module 610, configured to determine a first range index corresponding to a numerical range to be queried based on a preset correspondence between m numerical range intervals and range indexes; a leaf node computing module 620, configured to compute a corresponding first leaf node based on the first range index; a data block reading module 630, configured to read, in an oblivious random access manner, data blocks corresponding to the first leaf node from a tree-structured database, a data block of the data blocks including an address index and a range index corresponding to the address index; a target index determining module 640, configured to determine a target address index from the data blocks based on the first range index; a query vector generation module 650, configured to generate an n-dimensional query vector based on the target address index and the n address indexes; and a query result determining module 660, configured to determine a query result from the n pieces of data based on the n-dimensional query vector.

In an implementation, the leaf node computing module 620 is specifically configured to compute the corresponding first leaf node based on the first range index and a current query order.

In an implementation, the target index determining module 640 is specifically configured to search the data blocks for a target data block including the first range index, and use an address index in the target data block as the target address index.

In an implementation, the query vector generation module 650 is specifically configured to: construct an n-dimensional vector corresponding to locations of the n address indexes, set an element at a location of the target address index in the n-dimensional vector to a preset value that is not 0, and set another location to 0, to obtain the query vector.

In an implementation, the query result determining module 660 is specifically configured to obtain an n-dimensional query result based on a product of the n-dimensional query vector and a same-location element of a data vector, the data vector including the n pieces of data.

In an implementation, the tree-structured database is split into a plurality of tree-structured database shards that are respectively stored in a plurality of storage devices; and the data block reading module 630 includes a leaf node sending submodule 31, a data block receiving submodule 32, and a data block construction submodule 33. The leaf node sending submodule 31 is configured to separately send the first leaf node to storage devices of the plurality of storage devices, for the several storage devices to read, in an oblivious random access manner, several data block shards corresponding to the first leaf node from respective tree-structured database shards. The data block receiving submodule 32 is configured to receive the data block shards respectively sent by the several storage devices. The data block construction submodule 33 is configured to construct the data blocks based on the data block shards.

In an implementation, the apparatus 600 further includes: a query order update module, a leaf node update module, and a leaf node sending module (not shown in the figure). The query order update module is configured to: after the data block shards respectively sent by the several storage devices are received, update a current query order to obtain an updated query order; the leaf node update module is configured to: compute a corresponding second leaf node based on the first range index and the updated query order; and the leaf node sending module is configured to: separately send the second leaf node to the plurality of storage devices, so that the plurality of storage devices separately update corresponding data blocks in respective tree-structured database shards based on the second leaf node.

In an implementation, a piece of data in the n pieces of data is split into a plurality of data shards to obtain a plurality of shard groups each including n data shards, and the plurality of shard groups are respectively stored in a plurality of storage devices. The query result determining module 660 includes a query vector splitting submodule 61, a query vector sending submodule 62, a query result receiving submodule 63, and a query result determining submodule 64. The query vector splitting submodule 61 is configured to split the n-dimensional query vector into a plurality of n-dimensional query vector shards. The query vector sending submodule 62 is configured to correspondingly send the plurality of n-dimensional query vector shards to the plurality of storage devices separately, for the several storage devices to determine a query result shard based on respective n-dimensional query vector shards and n data shards. The query result receiving submodule 63 is configured to receive the query result shards sent by the plurality of storage devices. The query result determining submodule 64 is configured to determine the query result based on the query result shards received from the plurality of storage devices.

FIG. 7 is a schematic block diagram illustrating another numerical range query apparatus for privacy protection according to an implementation. An apparatus implementation corresponds to the method implementation shown in FIG. 5. The apparatus 700 is configured to perform range query on n pieces of data, where the n pieces of data correspond to n address indexes. A tree-structured database is used to store a data block, a data block of the data blocks includes an address index and a range index corresponding to the address index, the tree-structured database is split into a plurality of tree-structured database shards respectively stored in a plurality of storage devices, and the apparatus 700 is deployed in any storage device. The apparatus 700 includes: a leaf node receiving module 710, configured to receive a first leaf node sent by a query device, the first leaf node being computed based on a first range index, and the first range index being determined based on a preset correspondence between m numerical range intervals and range indexes and a numerical range to be queried; a block shard reading module 720, configured to read, in an oblivious random access manner, several data block shards corresponding to the first leaf node from tree-structured database shards stored in the storage device; and a block shard sending module 730, configured to send the several data block shards to the query device, so that the query device constructs data blocks based on data block shards sent by several storage devices, and determines a query result from the n pieces of data based on an n-dimensional query vector, the n-dimensional query vector being generated based on a target address index and the n address indexes, and the target address index being determined from the data blocks based on the first range index.

In an implementation, the apparatus 700 further includes a data block sorting module and a data block backfilling module (not shown in the figure). The leaf node receiving module 710 is further configured to receive a second leaf node sent by the query device, the second leaf node being computed based on the first range index and an updated query order. The data block sorting module is configured to sort, based on the second leaf node, the several data block shards by interacting with another storage device, to obtain sorted data block shards, so that each storage device performs same sorting on several data block shards of the storage device. The data block backfill module is configured to backfill the tree-structured database with the sorted data block shards.

In an implementation, the storage device includes a storage area and a sorting area, the storage area is used to store the several data block shards corresponding to the first leaf node that are read from the tree-structured database shards, and the sorting area is used to store the sorted data block shards.

FIG. 8 is a schematic block diagram illustrating still another numerical range query apparatus for privacy protection according to an implementation. An apparatus implementation corresponds to the method implementation shown in FIG. 5. The apparatus 800 is configured to perform range query on n pieces of data, where the n pieces of data correspond to n address indexes. A piece of data in the n pieces of data is split into a plurality of data shards to obtain a plurality of shard groups each including n data shards, the plurality of shard groups are respectively stored in a plurality of storage devices, and the apparatus 800 is deployed in any storage device. The apparatus 800 includes: a vector shard receiving module 810, configured to receive an n-dimensional query vector shard sent by a query device, the n-dimensional query vector shard being obtained through splitting from an n-dimensional query vector, the n-dimensional query vector being generated based on a target address index and the n address indexes, the target address index being determined from data blocks based on a first range index, the first range index being determined based on a preset correspondence between m numerical range intervals and a range index and a numerical range to be queried, and a data block of the data blocks including an address index and a range index corresponding to the address index; a result shard determining module 820, configured to determine a query result shard based on the n-dimensional query vector shard and n data shards stored by the storage device; and a result shard sending module 830, configured to send the query result shard to the query device, for the query device to construct a complete query result based on query result shards sent by storage devices.

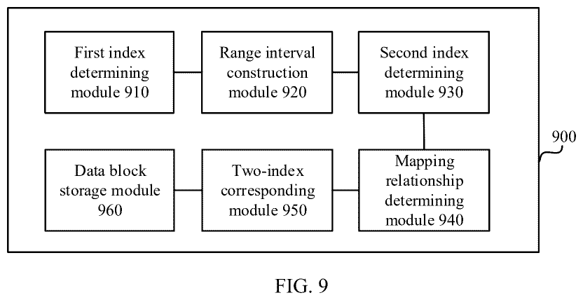

FIG. 9 is a schematic block diagram illustrating a data index construction apparatus for privacy protection according to an implementation. An apparatus implementation corresponds to the method implementation shown in FIG. 2. The apparatus is deployed in an intermediate trusted device and includes: a first index determining module 910, configured to determine n address indexes corresponding to n pieces of data, to obtain a first correspondence; a range interval construction module 920, configured to construct m numerical range intervals covering a numerical range of the n pieces of data; a second index determining module 930, configured to determine m range indexes corresponding to the m numerical range intervals, to obtain a second correspondence; a mapping relationship determining module 940, configured to separately map the n pieces of data to the m numerical range intervals to obtain a first mapping relationship; a two-index corresponding module 950, configured to determine address indexes respectively corresponding to the m range indexes based on the first mapping relationship, the first correspondence, and the second correspondence; and a data block storage module 960, configured to use an address index and a range index corresponding to the address index as a data block, compute a leaf node corresponding to the data block based on the range index, and store the data block into a tree-structured database based on the leaf node.

In an implementation, the range interval construction module 920 includes an extreme value determining submodule, an interval length determining submodule, and a range interval construction submodule (not shown in the figure). The extreme value determining submodule is configured to determine a maximum value and a minimum value of the n pieces of data. The interval length determining submodule is configured to determine, based on the maximum value and the minimum value, an interval length for constructing a numerical range interval. The range interval construction submodule is configured to construct the m numerical range intervals based on the interval length.

In an implementation, the interval length determining submodule is specifically configured to: compute a difference between the maximum value and the minimum value, compute an average value of the difference by using n, and determine the interval length based on the average value.

In an implementation, the range interval construction submodule is specifically configured to successively determine, starting from the minimum value, the m numerical range intervals by using the interval length as a step, m being a value obtained after 1 is added to n.

In an implementation, the two-index corresponding module 950 includes an initial correspondence submodule and an invalid index filling submodule (not shown in the figure). The initial correspondence submodule is configured to correspond the n address indexes to the m range indexes to obtain an initial correspondence. The invalid index filling submodule is configured to: fill in invalid address indexes in response to that a quantity of address indexes corresponding to a range index in the initial correspondence is less than a preset quantity of k, so that the quantity of address indexes corresponding to the range index reaches k. k is not less than a maximum value of the quantity of address indexes corresponding to the range index in the initial correspondence.

In an implementation, when computing the leaf node corresponding to the data block based on the range index, the data block storage module 960 computes the leaf node corresponding to the data block based on the range index and a query order.

In an implementation, the apparatus 900 further includes a database splitting module (not shown in the figure), configured to split the tree-structured database into a plurality of tree-structured database shards, and respectively store the tree-structured database shards into a plurality of storage devices.

The foregoing apparatus implementations are corresponding to the method implementations. For specific description, refer to the description in the part of the method implementations. Details are not described herein again. The apparatus implementation is obtained based on a corresponding method implementation, and has the same technical effect as the corresponding method implementation. For specific description, refer to the corresponding method implementation.

An implementation of this specification further provides a computer-readable storage medium, on which a computer program is stored. When the computer program is executed in a computer, the computer performs the method according to any one of FIG. 1 to FIG. 5.

An implementation of this specification further provides a computing device, including a memory and a processor, where the memory stores executable code, and when executing the executable code, the processor implements the method according to any one of FIG. 1 to FIG. 5.

The implementations in the present specification are described in a progressive way. For same or similar parts of the implementations, mutual references can be made to the implementations. Each implementation focuses on a difference from other implementations. Particularly, the storage medium and computer device implementations are basically similar to the method implementations, and therefore are described briefly. For related parts, references can be made to parts of the method implementation descriptions.

A person skilled in the art should be aware that, in the above one or more examples, the functions described in implementations of the present disclosure can be implemented by hardware, software, firmware, or any combination thereof. When software is used for implementation, these functions can be stored in a computer-readable medium or transmitted as one or more instructions or code on the computer-readable medium.

The foregoing specific implementations further describe the objectives, technical solutions, and beneficial effects of the implementations of the present disclosure in detail. It should be understood that the above descriptions are merely specific implementations of implementations of the present disclosure, but are not intended to limit the protection scope of the present disclosure. Any modification, equivalent replacement, or improvement made based on the technical solutions of the present disclosure shall fall within the protection scope of the present disclosure.

What is claimed is:

1. A numerical range query method, the method comprising:
determining, based on a correspondence between m numerical range intervals and range indexes, a first range index corresponding to a numerical range to be queried on n pieces of data corresponding to n address indexes;
computing a first leaf node based on the first range index;
obtaining, in an oblivious random access manner, data blocks corresponding to the first leaf node from a tree-structured database, a data block of the data blocks including an address index and a range index corresponding to the address index;
determining a target address index from the data blocks based on the first range index;
generating an n-dimensional query vector based on the target address index and the n address indexes; and
determining a query result from the n pieces of data based on the n-dimensional query vector.

2. The method according to claim 1, wherein the computing the corresponding first leaf node based on the first range index includes:
computing the corresponding first leaf node based on the first range index and a current query order.

3. The method according to claim 1, wherein the determining the target address index from the data blocks based on the first range index includes:
searching the data blocks for a target data block including the first range index, and determining an address index in the target data block as the target address index.

4. The method according to claim 1, wherein the generating the n-dimensional query vector based on the target address index and the n address indexes includes:
constructing an n-dimensional vector corresponding to locations of the n address indexes,
setting an element at a first location of the target address index in the n-dimensional vector to a value that is not 0, and
setting a second location in the n-dimensional vector to 0, to obtain the n-dimensional query vector.

5. The method according to claim 4, wherein the determining the query result from the n pieces of data based on the n-dimensional query vector includes:
obtaining an n-dimensional query result based on a product of the n-dimensional query vector and a same-location element of a data vector, the data vector including the n pieces of data.

6. The method according to claim 1, comprising splitting the tree-structured database into a plurality of tree-structured database shards that are respectively stored in a plurality of storage devices; and
wherein the obtaining the data blocks corresponding to the first leaf node from the tree-structured database includes:
separately sending the first leaf node to storage devices of the plurality of storage devices, for the storage devices to read, in an oblivious random access manner, data block shards corresponding to the first leaf node from respective tree-structured database shards;
receiving the data block shards respectively sent by the several storage devices; and
constructing the data blocks based on the data block shards.

7. The method according to claim 6, further comprising:
after the receiving the data block shards respectively sent by the storage devices,
updating a current query order to obtain an updated query order;
computing a second leaf node based on the first range index and the updated query order; and
separately sending the second leaf node to the plurality of storage devices, for the plurality of storage devices to separately update corresponding data blocks in respective tree-structured database shards based on the second leaf node.

8. The method according to claim 1, comprising splitting a piece of data in the n pieces of data into a plurality of data shards to obtain a plurality of shard groups each including n data shards, and causing the plurality of shard groups to be respectively stored in a plurality of storage devices;
wherein the determining the query result from the n pieces of data based on the n-dimensional query vector comprises:
splitting the n-dimensional query vector into a plurality of n-dimensional query vector shards;
sending the plurality of n-dimensional query vector shards to the plurality of storage devices, respectively, for the plurality of storage devices to determine a query result shard based on respective n-dimensional query vector shards and n data shards;
receiving the query result shards sent by the plurality of storage devices; and
determining the query result based on the query result shards received from the plurality of storage devices.

9. A computing system, comprising one or more processors and one or more storage devices, the one or more storage devices having computer executable instruction stored thereon, the computer executable instructions when executed by the one or more processors enabling the one or more processors to, individually or collectively, implement acts including:
determining, based on a correspondence between m numerical range intervals and range indexes, a first range index corresponding to a numerical range to be queried on n pieces of data corresponding to n address indexes;
computing a first leaf node based on the first range index;
obtaining, in an oblivious random access manner, data blocks corresponding to the first leaf node from a tree-structured database, a data block of the data blocks including an address index and a range index corresponding to the address index;
determining a target address index from the data blocks based on the first range index;
generating an n-dimensional query vector based on the target address index and the n address indexes; and
determining a query result from the n pieces of data based on the n-dimensional query vector.

10. The computing system according to claim 9, wherein the computing the corresponding first leaf node based on the first range index includes:
computing the corresponding first leaf node based on the first range index and a current query order.

11. The computing system according to claim 9, wherein the determining the target address index from the data blocks based on the first range index includes:
searching the data blocks for a target data block including the first range index, and determining an address index in the target data block as the target address index.

12. The computing system according to claim 9, wherein the generating the n-dimensional query vector based on the target address index and the n address indexes includes:
constructing an n-dimensional vector corresponding to locations of the n address indexes,
setting an element at a first location of the target address index in the n-dimensional vector to a value that is not 0, and
setting a second location in the n-dimensional vector to 0, to obtain the n-dimensional query vector.

13. The computing system according to claim 12, wherein the determining the query result from the n pieces of data based on the n-dimensional query vector includes:
obtaining an n-dimensional query result based on a product of the n-dimensional query vector and a same-location element of a data vector, the data vector including the n pieces of data.

14. The computing system according to claim 8, wherein the acts include splitting the tree-structured database into a plurality of tree-structured database shards that are respectively stored in a plurality of storage devices; and
wherein the obtaining the data blocks corresponding to the first leaf node from the tree-structured database includes:
separately sending the first leaf node to storage devices of the plurality of storage devices, for the storage devices to read, in an oblivious random access manner, data block shards corresponding to the first leaf node from respective tree-structured database shards;
receiving the data block shards respectively sent by the several storage devices; and
constructing the data blocks based on the data block shards.

15. The computing system according to claim 14, wherein the acts include:
after the receiving the data block shards respectively sent by the storage devices,
updating a current query order to obtain an updated query order;
computing a second leaf node based on the first range index and the updated query order; and
separately sending the second leaf node to the plurality of storage devices, for the plurality of storage devices to separately update corresponding data blocks in respective tree-structured database shards based on the second leaf node.

16. The computing system according to claim 9, wherein the acts include splitting a piece of data in the n pieces of data into a plurality of data shards to obtain a plurality of shard groups each including n data shards, and causing the plurality of shard groups to be respectively stored in a plurality of storage devices; and
wherein the determining the query result from the n pieces of data based on the n-dimensional query vector comprises:
splitting the n-dimensional query vector into a plurality of n-dimensional query vector shards;
sending the plurality of n-dimensional query vector shards to the plurality of storage devices, respectively, for the plurality of storage devices to determine a query result shard based on respective n-dimensional query vector shards and n data shards;
receiving the query result shards sent by the plurality of storage devices; and
determining the query result based on the query result shards received from the plurality of storage devices.

17. A non-transitory storage medium having computer executable instruction stored thereon, the computer executable instructions when executed by one or more processors enabling the one or more processors to, individually or collectively, implement acts including:
determining, based on a correspondence between m numerical range intervals and range indexes, a first range index corresponding to a numerical range to be queried on n pieces of data corresponding to n address indexes;
computing a first leaf node based on the first range index;
obtaining, in an oblivious random access manner, data blocks corresponding to the first leaf node from a tree-structured database, a data block of the data blocks including an address index and a range index corresponding to the address index;
determining a target address index from the data blocks based on the first range index;
generating an n-dimensional query vector based on the target address index and the n address indexes; and
determining a query result from the n pieces of data based on the n-dimensional query vector.

18. The non-transitory storage medium according to claim 17, wherein the computing the corresponding first leaf node based on the first range index includes:
computing the corresponding first leaf node based on the first range index and a current query order.

19. The non-transitory storage medium according to claim 17, wherein the determining the target address index from the data blocks based on the first range index includes:
searching the data blocks for a target data block including the first range index, and determining an address index in the target data block as the target address index.

20. The non-transitory storage medium according to claim 17, wherein the generating the n-dimensional query vector based on the target address index and the n address indexes includes:
constructing an n-dimensional vector corresponding to locations of the n address indexes,
setting an element at a first location of the target address index in the n-dimensional vector to a value that is not 0, and
setting a second location in the n-dimensional vector to 0, to obtain the n-dimensional query vector.
